(19) United States
(12) Patent Application Publication
(10) Pub. No.: US 2025/0267616 A1
(43) Pub. Date: Aug. 21, 2025

(54) PRIORITIZATION HANDLING FOR UPLINK GAP

(71) Applicant: APPLE INC., Cupertino, CA (US)

(72) Inventors: Jie Cui, San Jose, CA (US); Yang Tang, San Jose, CA (US); Dawei Zhang, Saratoga, CA (US); Hong He, San Jose, CA (US); Xiang Chen, Campbell, CA (US); Huaning Niu, San Jose, CA (US); Qiming Li, Beijing (CN); Manasa Raghavan, Sunnyvale, CA (US); Alexander Sirotkin, Hod Hasharon (IL)

(21) Appl. No.: 18/857,361

(22) PCT Filed: Apr. 24, 2022
(86) PCT No.: PCT/CN2022/088721

§ 371 Date: Oct. 16, 2024

(51) Int. Cl. H04W 64/00; H04L 5/00

(52) U.S. Cl. CPC H04W 64/00; H04L 5/0051

(57) ABSTRACT

Systems and methods for resolving collisions between uplink (UL) gap occasions and other occasions (e.g., positioning reference signal (PRS) measurement occasions, UL positioning reference signal (UL-PRS) transmission occasions, and/or channel state information (CSI) reporting occasions) are discussed herein. A user equipment (UE) may identify that a UL gap occasion collides with another type of occasion. The UE may determine to drop one of the UL gap occasion and the other type of occasion and to prioritize (e.g., perform one or more procedures corresponding to) the other of the UL gap occasion and the other type of occasion based on, for example, one or more effective periodicity (s) of PRS measurement occasions includes the first occasions or UL-PRS transmission occasions, a synchronization signaling block (SSB) periodicity, a CSI reference signal (CSI-RS) periodicity, or one or more CSI reporting periodicity (s) (as may be applicable in the various cases).

### TECHNICAL FIELD

This application relates generally to wireless communication systems, including wireless communications systems that may encounter collisions between UL gap occasions and occasions for other procedures (such as, e.g., PRS measurement occasions, UL-PRS transmission occasions, and/or CSI reporting occasions).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi©).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

A UE may be configured for uplink (UL) gap use. During a UL gap, it may be that the UE does not perform any data transmissions to a network (NW) in UL and/or does not attempt to receive and data transmissions from the NW in downlink (DL). Instead, the UE may use a UL gap to perform one or more UL gap procedures (e.g., procedures that leverage and/or are enabled by the fact that the UE is not currently performing NW communications).

Such UL gap procedures may include, for example, a body positioning sensing procedure. It may be that, in order to comply with governmental rules and regulations, a UE should attempt to avoid performing certain types of transmissions (e.g., beamformed transmissions) towards/through a human body that is proximate to the UE. Accordingly, a UE may use a UL gap (during which data transmissions with the NW are paused) to instead perform body positioning sensing in order to become aware of a direction and/or proximity of a human body (e.g., a body of the user of the UE) relative to the UE. During a UL gap, the UE may transmit a signal that is expected to be returned to the UE (with the return also occurring during the UL gap). Based on the characteristics of the signal as returned, the UE determines a direction and/or proximity of a obstacles that are proximate to the UE (which are presumed to possibly be/possibly include a human body). Having such information, the UE is enabled, during regular transmission with the NW (outside of the UE gap period), to use beamformings that are directed away from the positions of these obstacles relative to the UE.

Other UL gap procedures that the UE may perform during a UL gap may include (but are not limited to) power antenna (PA) efficiency and power consumption analysis, transceiver calibration (e.g., in view of temperature variation at the UE), and UE transmit power management/calibration.

A UE may be configured with one or more (e.g., periodic) uplink (UL) gap occasions during which the UE experiences a UL gap for during which one or more of the above UL gap procedures may be performed. Accordingly, the timing(s) of one or more upcoming UL gap occasions may be known to the UE.

It may be that one or more of these UL gap occasions may overlap or collide in time with other procedures that the UE is configured to perform. For example, a UL gap occasion may collide with an occasion for signaling related to UE positioning within the network (e.g., with a receipt of a DL positioning signal and/or with a transmission of a UL positioning signal). As another example, a UL gap occasion may collide with a CSI reporting occasion at the UE (e.g., corresponding to radio resource management (RRM) procedures that use such CSI reports).

It has been determined that due to varying configurations available at the UE for using positioning signaling and/or CSI reporting, dynamic determinations of whether (or not) to prioritize the UL gap over the positioning signaling or the CSI report (as the case may be) may result in a better use of NW resources than, for example, a simple blanket rule that merely prioritizes (or not) the UL gap regardless of configurations for the positioning signaling and/or CSI reporting.

FIG. 1 illustrates a dropping arrangement showing prioritization between UL gap occasions and PRS measurement occasions, according to an embodiment.

FIG. 2 illustrates a method of a UE, according to an embodiment.

FIG. 3 illustrates a dropping arrangement showing prioritization between UL gap occasions and UL-PRS transmission occasions, according to an embodiment.

FIG. 4 illustrates a method of a UE, according to an embodiment.

FIG. 5 illustrates a method of a UE, according to an embodiment.

FIG. 6 illustrates a method of a UE, according to an embodiment.

FIG. 7 illustrates a method of a UE, according to an embodiment.

FIG. 8 illustrates a method of a UE, according to an embodiment.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Embodiments for Prioritization Between UL Gaps and Positioning Signals

In some cases, it may be that a UL gap occasion collides with a DL positioning measurement occasion at the UE. For example, it may be that a UL gap occasion collides with a positioning reference signal (PRS) measurement occasion. A PRS measurement occasion may be a time period during which the UE attempts to receive and/or measure a PRS from the network.

The UE may understand that a set of PRS measurement occasions occurs according to an effective periodicity for such PRS measurement occasions. In some cases, it may be that the UE receives a configured PRS periodicity from the base station, and this configured PRS periodicity is directly used as the effective periodicity for a set of PRS measurement occasions.

In other cases, in addition to receiving a configured PRS periodicity from the base station, the UE may receive a muting pattern. In such a case, an effective periodicity for a set of PRS measurement occasions that is used by the UE may be determined by applying the muting pattern to the configured PRS periodicity. For example, a UE may receive a configured PRS periodicity of T milliseconds (ms), and may further receive a muting pattern as a bitmap “10101010” (with each bit being understood to correspond to individual instances of periods T according to the configured PRS periodicity). In such a case, because every other period T corresponding to the configured PRS periodicity corresponds to a 0 bit in the muting pattern, the effective periodicity for the set of PRS measurement occasions used by the UE would ultimately be 2T. In other words, although the UE has a configured PRS periodicity of T, the UE would understand that PRS measurement occasions in fact occur at an interval 2T due to the effect of the muting pattern. Thus, the effective periodicity for the set of PRS measurement occasions at the UE is 2T.

When a collision between a UL gap occasion and a PRS measurement occasion occurs, the UE may dynamically determine to prioritize one of the UL gap occasion and the PRS measurement occasion based on the effective periodicity for the PRS measurement occasions at the UE. Such a prioritization may involve taking one or more actions corresponding to the prioritized one of the UL gap occasion and the PRS measurement occasion and/or dropping (e.g., not taking any actions corresponding to) the non-prioritized one of the UL gap occasion and the PRS measurement occasion. Such prioritization may be performed based on the result of a comparison of the effective periodicity for the set of PRS measurement occasions to an upper threshold.

In a first option for prioritizing one of the PRS measurement occasion and the UL gap occasion, if the result of the comparison of the effective periodicity for the set of PRS measurement occasions to the upper threshold is that the effective periodicity for the set of PRS measurement occasions is within the upper threshold (e.g., is less than or alternatively is less than or equal to the upper threshold), the UE prioritizes the UL gap occasion over the PRS measurement occasion. In other words, the UE may drop the PRS measurement occasion and perform one or more UL gap procedures during the UL gap occasion. The prioritization of the UL gap occasion over the PRS measurement occasion in this case may reflect an understanding that because the effective periodicity for the set of PRS measurement occasions at the UE is smaller than the upper threshold, there may be other PRS measurement occasion(s) of the set during which a PRS measurement can be performed within an acceptable timeframe even after the present PRS measurement occasion is dropped.

Otherwise, if the effective periodicity for the set of PRS measurement occasions is not within the upper threshold (e.g., is greater than or alternatively greater than or equal to the upper threshold), the UE prioritizes the PRS measurement occasion over the UL gap. In other words, the UE may drop the UL gap occasion and perform a measurement of a PRS received from the NW during the PRS measurement occasion. The prioritization of the PRS measurement occasion over the UL gap occasion in this case may reflect an understanding that because the effective periodicity for the set of PRS measurement occasions at the UE is larger than the upper threshold, there may be no other PRS measurement occasion(s) of the set during which a PRS measurement can be performed within an acceptable timeframe if the current PRS measurement occasion is dropped.

In a second option for prioritizing one of the PRS measurement occasion and the UL gap occasion, if the result of the comparison of the effective periodicity for the set of PRS measurement occasions to the upper threshold is that the effective periodicity for the set of PRS measurement occasions is within the upper threshold (e.g., is less than or alternatively is less than or equal to the upper threshold), the possibility that the UE prioritizes the UL gap occasion over the PRS measurement occasion (as in the first option for prioritizing one of the PRS measurement occasion and the UL gap occasion) is left open, pending a second result of a second comparison regarding a second effective periodicity that would apply at the UE in the case that one or more PRS measurement occasions (including the PRS measurement occasion that collides with the UL gap) of the set are dropped.

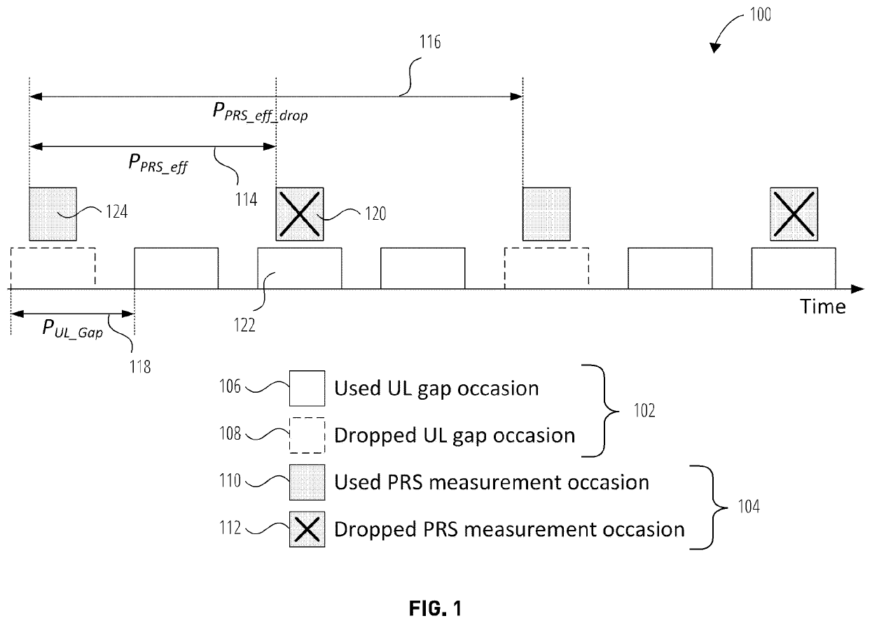

FIG. 1 illustrates a dropping arrangement 100 showing prioritization between UL gap occasions 102 and PRS measurement occasions 104, according to an embodiment. Within the UL gap occasions 102, the dropping arrangement 100 illustrates used UL gap occasions 106 and dropped UL gap occasions 108. Within the PRS measurement occasions 104, the dropping arrangement 100 illustrates used PRS measurement occasions 110 and dropped PRS measurement occasions 112. The dropping arrangement 100 further illustrates a first effective periodicity 114, a second effective periodicity 116, and a UL gap periodicity 118.

It should be understood that the dropping arrangement 100 illustrates prioritization actions between collided UL gap occasions 102 and PRS measurement occasions 104 that are under consideration by the UE (e.g., which may (or may not) be ultimately carried out by the UE as provided in the dropping arrangement 100 pending further analysis by the UE as will be described).

Corresponding to the second option for prioritizing one of the PRS measurement occasion and the UL gap occasion, the first effective periodicity 114 may be understood to be the effective periodicity that applies prior to any dropping of any of the dropped PRS measurement occasions 112 by the UE. In other words, the first effective periodicity 114 may be determinable according to a first set of PRS measurement occasions that includes both the used PRS measurement occasions 110 and the dropped PRS measurement occasions 112 (prior to any dropping of the dropped PRS measurement occasions 112). This first effective periodicity 114 may be understood to correspond to the (single) effective periodicity discussed previously in relation to the first option for prioritizing one of the PRS measurement occasion and the UL gap occasion. The first effective periodicity 114 uses the label “PPRS_eff” in the dropping arrangement 100.

The second effective periodicity 116 may be determined by the UE to be the effective periodicity that would be used at the UE in the case that the dropping of the dropped PRS measurement occasions 112 as illustrated in the dropping arrangement 100 is actually ultimately carried out. A second set of PRS measurement occasions may be determined by the UE by omitting the dropped PRS measurement occasions 112 from the first set of PRS measurement occasions (that includes both the used PRS measurement occasions 110 and the dropped PRS measurement occasions 112), with the result that the second set of PRS measurement occasions includes only the used PRS measurement occasions 110. Thus, the second set of PRS measurement occasions is a subset of the first PRS measurement occasions in such a case. The second effective periodicity 116 is accordingly a periodicity between PRS occasions of this second set of PRS measurement occasions (e.g., between the used PRS measurement occasions 110). The second effective periodicity 116 uses the label “P_{PRS_eff_drop}” in the dropping arrangement 100.

Note that a dropping arrangement used to determine a second effective periodicity considers the PRS measurement occasion of the collision currently being resolved as one of the dropped PRS measurement occasions 112 (thus, in the dropping arrangement 100, the collision currently being resolved could be, for example, the collision between the PRS measurement occasion 120 and the UL gap occasion 122). If a different collision were instead being considered, a (potentially different) dropping arrangement used to ultimately determine a second effective periodicity would consider the PRS measurement occasion corresponding to that collision as dropped.

Once the second effective periodicity 116 that would be applicable if the dropped PRS measurement occasions 112 were in fact dropped has been determined, the UE may then perform a second comparison between second effective periodicity 116 and the upper threshold. If the result of the second comparison is that the second effective periodicity 116 for the second set of PRS measurement occasions is within the upper threshold (e.g., is less than or alternatively is less than or equal to the upper threshold), the UE prioritizes the present UL gap occasion over the PRS measurement occasion. In other words, the UE may proceed drop the PRS measurement occasion and perform one or more UL gap procedures during the UL gap occasion. In such a case, the dropping arrangement 100 is ultimately used by the UE. The prioritization of the PRS measurement occasion over the UL gap occasion in this case may reflect an understanding that because the second effective periodicity 116 for the second set of PRS measurement occasions at the UE is smaller than the upper threshold, there will be other PRS measurement occasion(s) during which a PRS measurement can be performed within an acceptable timeframe (e.g., the used PRS measurement occasions 110) even after the present PRS measurement is dropped.

If the result of the second comparison is instead that second effective periodicity 116 for the second set of PRS measurement occasions is not within the upper threshold (e.g., is less than or alternatively is less than or equal to the upper threshold), the UE would instead prioritize the PRS measurement occasion over the UL gap occasion. In other words, the UE may drop present UL gap occasion and perform a measurement of a PRS received from the NW during the PRS measurement occasion. In such a case, the dropping arrangement 100 is not ultimately used by the UE. The prioritization of the PRS measurement occasion over the UL gap occasion in this case may reflect an understanding that because the second effective periodicity 116 for the second set of PRS measurement occasions at the UE is larger than the upper threshold, there may be not be other PRS measurement occasion(s) during which a PRS measurement can be performed within an acceptable timeframe if the current PRS measurement occasion is dropped.

In a case that the dropping arrangement 100 is used, it may be that the UE resolves the collision between the PRS measurement occasion 120 and the UL gap occasion 122 by dropping the PRS measurement occasion 120 and using the UL gap occasion 122. To arrive at this result, the UE performed a first comparison between the first effective periodicity 114 and an upper threshold, with the result that the first effective periodicity 114 was less than (or alternatively less than or equal to) the upper threshold. Then, the UE determined a second effective periodicity 116 that would apply at the UE relative to the dropping of the dropped PRS measurement occasions 112 (where the dropped PRS measurement occasions 112 include the PRS measurement occasion 120 for the collision currently being analyzed). The UE then compared the second effective periodicity 116 to the upper threshold, with the result that the second effective periodicity 116 was (also) less than (or alternatively less than or equal to) the upper threshold. Accordingly, the UE dropped the PRS measurement occasion 120 and used the UL gap occasion 122, according to an actual use of the dropping arrangement 100.

Supposing an alternative case of resolving the collision of the PRS measurement occasion 120 and the UL gap occasion 122 where the UE were to instead first attempt to use a dropping arrangement that dropped both the PRS measurement occasion 120 and the PRS measurement occasion 124, the resulting second effective periodicity (which would be larger than the second effective periodicity 116) may be larger than the upper threshold. In such a case, the UE would accordingly determine that the PRS measurement occasion 120 and the PRS measurement occasion 124 cannot both be dropped per that dropping arrangement. The UE may then proceed to try different dropping arrangement(s) and may ultimately arrive at the dropping arrangement 100 (which drops only the PRS measurement occasion 120 and not the PRS measurement occasion 124).

It is contemplated that in alternative cases, a dropping arrangement that drops both the PRS measurement occasion 120 and the PRS measurement occasion 124 may result in a second effective periodicity that is still within the upper threshold. In such cases, the UE may proceed to actually drop both the PRS measurement occasion 120 and the PRS measurement occasion 124 according to that dropping arrangement.

In some embodiments of either of the first option and/or the second option for prioritizing one of the PRS measurement occasion and the UL gap occasion, an upper threshold as has been discussed is pre-defined at the UE. In other embodiments, the upper threshold may be configured to the UE by the NW.

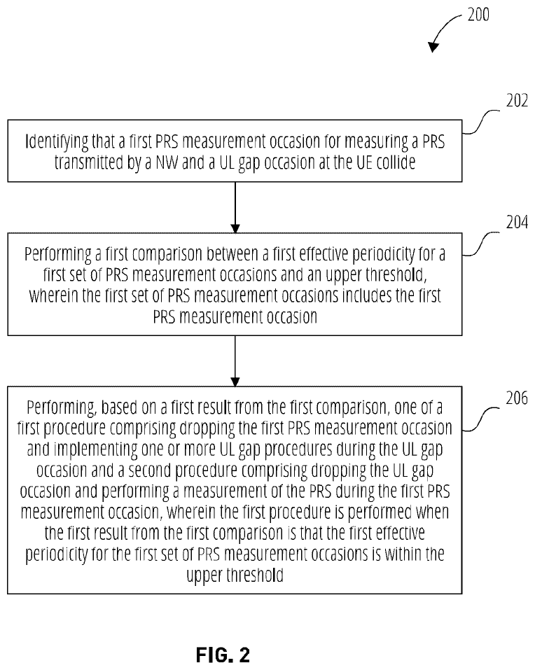

FIG. 2 illustrates a method 200 of a UE, according to an embodiment. The method 200 includes identifying 202 that a first PRS measurement occasion for measuring a PRS transmitted by a NW and a UL gap occasion at the UE collide.

The method 200 further includes performing 204 a first comparison between a first effective periodicity for a first set of PRS measurement occasions and an upper threshold, wherein the first set of PRS measurement occasions includes the first PRS measurement occasion.

The method 200 further includes performing 206, based on a first result from the first comparison, one of a first procedure comprising dropping the first PRS measurement occasion and implementing one or more UL gap procedures during the UL gap occasion and a second procedure comprising dropping the UL gap occasion and performing a measurement of the PRS during the first PRS measurement occasion; wherein the first procedure is performed when the first result from the first comparison is that the first effective periodicity for the first set of PRS measurement occasions is within the upper threshold.

In some embodiments, the method 200 further includes determining a second effective periodicity for a second set of PRS measurement occasions, wherein the second set of PRS measurement occasions is a subset of the first set of PRS measurement occasions that excludes the first PRS measurement occasion and performing a second comparison between the second effective periodicity for the second set of PRS measurement occasions and the upper threshold, wherein the performing the one of the first procedure and the second procedure is further based on a second result from the second comparison, and wherein the first procedure is performed when the result from the second comparison is that the second effective periodicity for the second set of PRS measurement occasions is within the upper threshold. In some of these embodiments, the method 200 further comprises determining the second set of PRS measurement occasions by omitting one or more PRS measurement occasions including the first PRS measurement occasion from the first set of PRS measurement occasions.

In some embodiments, the method 200 further includes determining the first effective periodicity for the first set of PRS measurement occasions by applying a muting pattern to a configured PRS periodicity.

In some embodiments, the method 200 further includes receiving, from the NW, the upper threshold.

Embodiments contemplated herein include an apparatus comprising means to perform one or more elements of the method 200. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 200. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 200. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 200. This apparatus may be, for example, an apparatus of a UE (such as a wireless device 1002 that is a UE, as described herein).

Embodiments contemplated herein include a signal as described in or related to one or more elements of the method 200.

Embodiments contemplated herein include a computer program or computer program product comprising instructions, wherein execution of the program by a processor is to cause the processor to carry out one or more elements of the method 200. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

In some cases, it may be that a UL gap occasion collides with a UL transmission occasion at the UE for an uplink positioning reference signal (UL-PRS). Such a UL transmission occasion may be referred to herein as an “UL-PRS transmission occasion.” A UL-PRS transmission occasion may be a time period during which the UE transmits a UL-PRS to the network.

In some cases, a UL-PRS may be a sounding reference signal (SRS). The use of other types of reference signals as UL-PRSs is also contemplated.

The UE may understand that a set of UL-PRS transmission occasions occurs according to an effective periodicity for such UL-PRS transmission occasions. In some cases, it may be that the UE receives a configured UL-PRS periodicity from the base station, and this configured UL-PRS periodicity is directly used as the effective periodicity for a set of UL-PRS transmission occasions.

In other cases, in addition to receiving a configured UL-PRS periodicity from the base station, the UE may receive a muting pattern. In such a case, an effective periodicity for a set of UL-PRS transmission occasions that is used by the UE may be determined by applying the muting pattern to the configured UL-PRS periodicity. For example, a UE may receive a configured UL-PRS periodicity of T milliseconds (ms), and may further receive a muting pattern as a bitmap “10101010” (with each bit being understood to correspond to individual instances of periods T according to the configured UL-PRS periodicity). In such a case, because every other period T corresponding to the configured UL-PRS periodicity corresponds to a 0 bit in the muting pattern, the effective periodicity for the set of UL-PRS transmission occasions used by the UE would ultimately be 2T. In other words, although the UE has a configured UL-PRS periodicity of T, the UE would understand that UL-PRS transmission occasions in fact occur at an interval 2T due to the effect of the muting pattern. Thus, the effective periodicity for the set of UL-PRS transmission occasions at the UE is 2T.

When a collision between a UL gap occasion and a UL-PRS transmission occasion occurs, the UE may dynamically determine to prioritize one of the UL gap occasion and the UL-PRS transmission occasion based on the effective periodicity for the UL-PRS transmission occasions at the UE. Such a prioritization may involve taking one or more actions corresponding to the prioritized one of the UL gap occasion and the UL-PRS transmission occasion and/or dropping (e.g., not taking any actions corresponding to) the non-prioritized one of the UL gap occasion and the UL-PRS transmission occasion. Such prioritization may be performed based on the result of a comparison of the effective periodicity for the set of UL-PRS transmission occasions to an upper threshold.

In a first option for prioritizing one of the UL-PRS transmission occasion and the UL gap occasion, if the result of the comparison of the effective periodicity for the set of UL-PRS transmission occasions to the upper threshold is that the effective periodicity for the set of UL-PRS transmission occasions is within the upper threshold (e.g., is less than or alternatively is less than or equal to the upper threshold), the UE prioritizes the UL gap occasion over the UL-PRS transmission occasion. In other words, the UE may drop the UL-PRS transmission occasion and perform one or more UL gap procedures during the UL gap occasion. The prioritization of the UL gap occasion over the UL-PRS transmission occasion in this case may reflect an understanding that because the effective periodicity for the set of UL-PRS transmission occasions at the UE is smaller than the upper threshold, there may be other UL-PRS transmission occasion(s) of the set during which a UL-PRS transmission can be performed within an acceptable timeframe even after the present UL-PRS transmission occasion is dropped.

Otherwise, if the effective periodicity for the set of UL-PRS transmission occasions is not within the upper threshold (e.g., is greater than or alternatively greater than or equal to the upper threshold), the UE prioritizes the UL-PRS transmission occasion over the UL gap. In other words, the UE may drop the UL gap occasion and perform a transmission of a UL-PRS to the NW during the UL-PRS transmission occasion. The prioritization of the UL-PRS transmission occasion over the UL gap occasion in this case may reflect an understanding that because the effective periodicity for the set of UL-PRS transmission occasions at the UE is larger than the upper threshold, there may be no other UL-PRS transmission occasion(s) of the set during which a UL-PRS transmission can be performed within an acceptable timeframe if the current UL-PRS transmission occasion is dropped.

In a second option for prioritizing one of the UL-PRS transmission occasion and the UL gap occasion, if the result of the comparison of the effective periodicity for the set of UL-PRS transmission occasions to the upper threshold is that the effective periodicity for the set of UL-PRS transmission occasions is within the upper threshold (e.g., is less than or alternatively is less than or equal to the upper threshold), the possibility that the UE prioritizes the UL gap occasion over the UL-PRS transmission occasion (as in the first option for prioritizing one of the UL-PRS transmission occasion and the UL gap occasion) is left open, pending a second result of a second comparison regarding a second effective periodicity that would apply at the UE in the case that one or more UL-PRS transmission occasions (including the UL-PRS transmission occasion that collides with the UL gap) of the set are dropped.

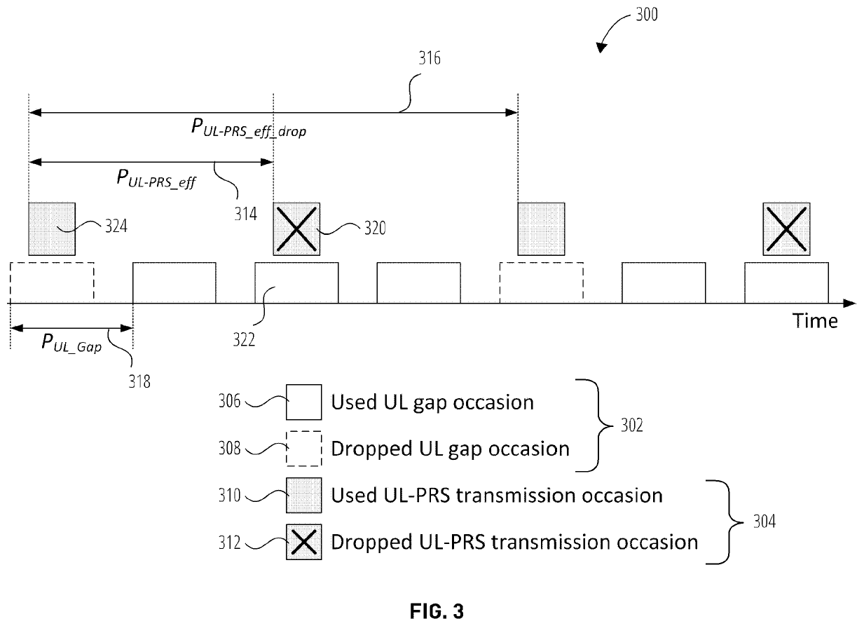

FIG. 3 illustrates a dropping arrangement 300 showing prioritization between UL gap occasions 302 and UL-PRS transmission occasions 304, according to an embodiment. Within the UL gap occasions 302, the dropping arrangement 300 illustrates used UL gap occasions 306 and dropped UL gap occasions 308. Within the UL-PRS transmission occasions 304, the dropping arrangement 300 illustrates used UL-PRS transmission occasions 310 and dropped UL-PRS transmission occasions 312. The dropping arrangement 300 further illustrates a first effective periodicity 314, a second effective periodicity 316, and a UL gap periodicity 318.

It should be understood that the dropping arrangement 300 illustrates prioritization actions between collided UL gap occasions 302 and UL-PRS transmission occasions 304 that are under consideration by the UE (e.g., which may (or may not) be ultimately carried out by the UE as provided in the dropping arrangement 300 pending further analysis by the UE as will be described).

Corresponding to the second option, the first effective periodicity 314 may be understood to be the effective periodicity that applies prior to any dropping of any of the dropped UL-PRS transmission occasions 312 by the UE. In other words, the first effective periodicity 314 may be determinable according to a first set of UL-PRS transmission occasions that includes both the used UL-PRS transmission occasions 310 and the dropped UL-PRS transmission occasions 312 (prior to any dropping of the dropped UL-PRS transmission occasions 312). This first effective periodicity 314 may be understood to correspond to the (single) effective periodicity discussed previously in relation to the first option for prioritizing one of the UL-PRS transmission occasion and the UL gap occasion. The first effective periodicity 314 uses the label “P_{UL_PRS_eff}” in the dropping arrangement 300.

The second effective periodicity 316 may be determined by the UE to be the effective periodicity that would be used at the UE in the case that the dropping of the dropped UL-PRS transmission occasions 312 as illustrated in the dropping arrangement 300 is actually ultimately carried out. A second set of UL-PRS transmission occasions may be determined by the UE by omitting the dropped UL-PRS transmission occasions 312 from the first set of UL-PRS transmission occasions (that includes both the used UL-PRS transmission occasions 310 and the dropped UL-PRS transmission occasions 312), with the result that the second set of UL-PRS transmission occasions includes only the used UL-PRS transmission occasions 310. Thus, the second set of UL-PRS transmission occasions is a subset of the first UL-PRS transmission occasions in such a case. The second effective periodicity 316 is accordingly a periodicity between UL-PRS occasions of this second set of UL-PRS transmission occasions (e.g., between the used UL-PRS transmission occasions 310). The second effective periodicity 316 uses the label “P_{UL-PRS_eff_drop}” in the dropping arrangement 300.

Note that a dropping arrangement used to determine a second effective periodicity considers the UL-PRS transmission occasion of the collision currently being resolved as one of the dropped UL-PRS transmission occasions 312 (thus, in the dropping arrangement 300, the collision currently being resolved could be, for example, the collision between the UL-PRS transmission occasion 320 and the UL gap occasion 322). If a different collision were instead being considered, a (potentially different) dropping arrangement used to ultimately determine a second effective periodicity would consider the UL-PRS transmission occasion corresponding to that collision as dropped.

Once the second effective periodicity 316 that would be applicable if the dropped UL-PRS transmission occasions 312 were in fact dropped has been determined, the UE may then perform a second comparison between second effective periodicity 316 and the upper threshold. If the result of the second comparison is that the second effective periodicity 316 for the second set of UL-PRS transmission occasions is within the upper threshold (e.g., is less than or alternatively is less than or equal to the upper threshold), the UE prioritizes the present UL gap occasion over the UL-PRS transmission occasion. In other words, the UE may proceed drop the UL-PRS transmission occasion and perform one or more UL gap procedures during the UL gap occasion. In such a case, the dropping arrangement 300 is ultimately used by the UE. The prioritization of the UL-PRS transmission occasion over the UL gap occasion in this case may reflect an understanding that because the second effective periodicity 316 for the second set of UL-PRS transmission occasions at the UE is smaller than the upper threshold, there may be other UL-PRS transmission occasion(s) during which a UL-PRS transmission can be performed within an acceptable timeframe (e.g., the used UL-PRS transmission occasions 310) even after the present UL-PRS transmission is dropped.

If the result of the second comparison is instead that second effective periodicity 316 for the second set of UL-PRS transmission occasions is not within the upper threshold (e.g., is less than or alternatively is less than or equal to the upper threshold), the UE would instead prioritize the UL-PRS transmission occasion over the UL gap occasion. In other words, the UE may drop present UL gap occasion and perform a transmission of a UL-PRS to the NW during the UL-PRS transmission occasion. In such a case, the dropping arrangement 300 is not ultimately used by the UE. The prioritization of the UL-PRS transmission occasion over the UL gap occasion in this case may reflect an understanding that because the second effective periodicity 316 for the second set of UL-PRS transmission occasions at the UE is larger than the upper threshold, there may not be other UL-PRS transmission occasion(s) during which a UL-PRS transmission can be performed within an acceptable timeframe if the current UL-PRS transmission occasion is dropped.

In a case where the dropping arrangement 300 is used, it may be that the UE resolves the collision between the UL-PRS transmission occasion 320 and the UL gap occasion 322 by dropping the UL-PRS transmission occasion 320 and using the UL gap occasion 322. To arrive at this result, the UE performed a first comparison between the first effective periodicity 314 and an upper threshold, with the result that the first effective periodicity 314 was less than (or alternatively less than or equal to) the upper threshold. Then, the UE determined a second effective periodicity 316 that would apply at the UE relative to the dropping of the dropped UL-PRS transmission occasions 312 (where the dropped UL-PRS transmission occasions 312 include the UL-PRS transmission occasion 320 for the collision currently being analyzed). The UE then compared the second effective periodicity 316 to the upper threshold, with the result that the second effective periodicity 316 was (also) less than (or alternatively less than or equal to) the upper threshold. Accordingly, the UE dropped the UL-PRS transmission occasion 320 and used the UL gap occasion 322, according to an actual use of the dropping arrangement 300.

Supposing an alternative case of resolving the collision of the UL-PRS transmission occasion 320 and the UL gap occasion 322 where the UE were to instead first attempt to use a dropping arrangement that dropped both the UL-PRS transmission occasion 320 and the UL-PRS transmission occasion 324, the resulting second effective periodicity (which would be larger than the second effective periodicity 316) may be larger than the upper threshold. In such a case, the UE would accordingly determine that the UL-PRS transmission occasion 320 and the UL-PRS transmission occasion 324 cannot both be dropped per that dropping arrangement. The UE may then proceed to try different dropping arrangement(s) and may ultimately arrive at the dropping arrangement 300 (which drops only the UL-PRS transmission occasion 320 and not the UL-PRS transmission occasion 324).

It is contemplated that in alternative cases, a dropping arrangement that drops both the UL-PRS transmission occasion 320 and the UL-PRS transmission occasion 324 may result in a second effective periodicity that is still within the upper threshold. In such cases, the UE may proceed to actually drop both the UL-PRS transmission occasion 320 and the UL-PRS transmission occasion 324 according to that dropping arrangement.

In some embodiments of either of the first option and/or the second option for prioritizing one of the UL-PRS transmission occasion and the UL gap occasion, an upper threshold as has been discussed is pre-defined at the UE. In other embodiments, the upper threshold may be configured to the UE by the NW.

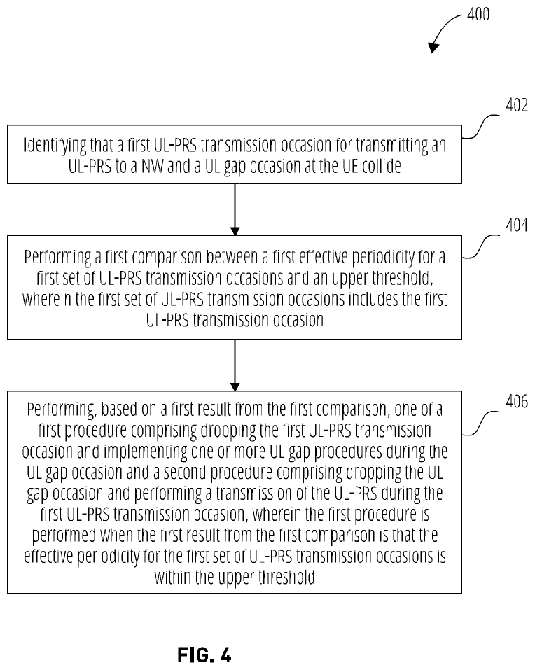

FIG. 4 illustrates a method 400 of a UE, according to an embodiment. The method 400 includes identifying 402 that a first UL-PRS transmission occasion for transmitting a UL-PRS to a NW and a UL gap occasion at the UE collide.

The method 400 further includes performing 404 a first comparison between a first effective periodicity for a first set of UL-PRS transmission occasions and an upper threshold, wherein the first set of UL-PRS transmission occasions includes the first UL-PRS transmission occasion.

The method 400 further includes performing 406, based on a first result from the first comparison, one of a first procedure comprising dropping the first UL-PRS transmission occasion and implementing one or more UL gap procedures during the UL gap occasion and a second procedure comprising dropping the UL gap occasion and performing a transmission of the UL-PRS during the first UL-PRS transmission occasion, wherein the first procedure is performed when the first result from the first comparison is that the effective periodicity for the first set of UL-PRS transmission occasions is within the upper threshold.

In some embodiments, the method 400 further includes determining a second effective periodicity for a second set of UL-PRS transmission occasions; wherein the second set of UL-PRS transmission occasions is a subset of the first set of UL-PRS transmission occasions that excludes the first UL-PRS transmission occasion and performing a second comparison between the second effective periodicity for the second set of UL-PRS transmission occasions and the upper threshold, wherein the performing the one of the first procedure and the second procedure is further based on a second result from the second comparison, and wherein the first procedure is performed when the result from the second comparison is that the second effective periodicity for the second set of UL-PRS transmission occasions is within the upper threshold. In some of these embodiments, the method 400 further includes determining the second set of UL-PRS transmission occasions by omitting one or more UL-PRS transmission occasions including the first UL-PRS transmission occasion from the first set of UL-PRS transmission occasions.

In some embodiments, the method 400 further includes determining the first effective periodicity for the first set of UL-PRS transmission occasions by applying a muting pattern to a configured UL-PRS periodicity.

In some embodiments, the method 400 further includes receiving, from the NW, the upper threshold.

In some embodiments of the method 400, the UL-PRS is an SRS.

Embodiments contemplated herein include an apparatus comprising means to perform one or more elements of the method 400. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 400. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a UE (such as a wireless device 1002 that is a UE, as described herein).

Embodiments contemplated herein include a signal as described in or related to one or more elements of the method 400.

Embodiments contemplated herein include a computer program or computer program product comprising instructions, wherein execution of the program by a processor is to cause the processor to carry out one or more elements of the method 400. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

### Embodiments for Prioritization Between UL Gaps and CSI Reporting

In some cases, it may be that a UL gap occasion collides with a CSI reporting occasion at the UE. A CSI reporting occasion may be a time period during which the UE transmits a CSI report (e.g., based on a measurement of a CSI reference signal (CSI-RS) or a synchronization signal block (SSB)) to the NW.

In some embodiments, such a collision may occur during a secondary cell (SCell) activation at the UE corresponding to carrier aggregation (CA) methods used by the UE.

Some methods for prioritizing between UL gap occasions and CSI reporting occasions that collide during SCell activation may consider a CSI-RS periodicity for CSI reporting and an SSB periodicity. One example case where this may be relevant is a case where the UE is performing SCell activation for a case of intra-band FR2 CA and/or for inter-band FR2 CA where common beam management (CBM) is used between the SCell and a current serving cell of the UE. In such cases, if the SCell being activated is in FR2 and if there is at least one active serving cell on the FR2 band, then T_{activation_time} is T_{SSB}+5 ms, provided that the UE has been provided with an SSB-based RRM measurement timing configuration (SMTC) for the SCell, the SSBs in the serving cell(s) and the SSBs in the SCell have the same downlink spatial domain transmission filter on one OFDM symbol in the same band in FR2, the parameter “ssb-PositionsInBurst” is the same for the serving cell(s) and the SCell, and the SSB is in the same half-frame on the SCell and a contiguous FR2 active serving cell. In such circumstances, a prioritization between a UL gap occasion and a CSI reporting occasion may be based on either the SSB periodicity or the CSI-RS periodicity. In such circumstances, SSBs of the SCell are aligned to the current serving cell(s), and thus a method for prioritizing between UL gap occasions and CSI reporting occasions may rationally consider both the CSI-RS periodicity for CSI reporting and the SSB periodicity.

When a collision between a UL gap occasion and a CSI reporting occasion occurs during an FR2 SCell activation procedure, the UE may dynamically determine to prioritize one of the UL gap occasion and the CSI reporting occasion based on an analysis of an SSB periodicity of the target SCell and a CSI-RS periodicity for CSI reporting on the target SCell in view of an upper threshold. Note that each of the SSB periodicity and the CSI-RS periodicity for CSI reporting may be known to the UE via NW configuration.

In the case that either of the SSB periodicity of the target SCell or the CSI-RS periodicity for CSI reporting on the target SCell is within the upper threshold (e.g., is less than or alternatively is less than or equal to the upper threshold), the UE prioritizes the CSI reporting occasion over the UL gap occasion. In other words, the UE may drop the UL gap occasion and perform a transmission of the CSI report during the CSI reporting occasion. The prioritization of the CSI reporting occasion over the UL gap occasion in this case may reflect an understanding that because one or both of the SSB periodicity and/or the CSI-RS periodicity for CSI reporting is smaller than the upper threshold, an associated SCell activation time is also small, and therefore any interruption in the use of UL gap procedures at the UE as caused by the prioritization of CSI reporting occasion(s) for such CSI report(s) attendant to the period of the SCell activation process will not interfere with too many UL gap occasions.

In the case that neither of the SSB periodicity of the target SCell or the CSI-RS periodicity for CSI reporting on the target SCell is within the upper threshold (e.g., is greater than or alternatively is greater than or equal to the upper threshold), the UE prioritizes the UL gap occasion over the CSI reporting occasion. In other words, the UE may drop the CSI reporting occasion and implement one or more UL gap procedures during the UL gap occasion. The prioritization of the UL gap occasion over the CSI reporting occasion in this case in this case may reflect an understanding that because both of the SSB periodicity and/or the CSI-RS periodicity for CSI reporting is larger than the upper threshold, an associated SCell activation time is also large, and therefore any interruption in the use of UL gap procedures at the UE as caused by the prioritization of CSI reporting occasion(s) for such CSI report(s) attendant to the period of the SCell activation process may interfere with more UL gap occasions than is desirable.

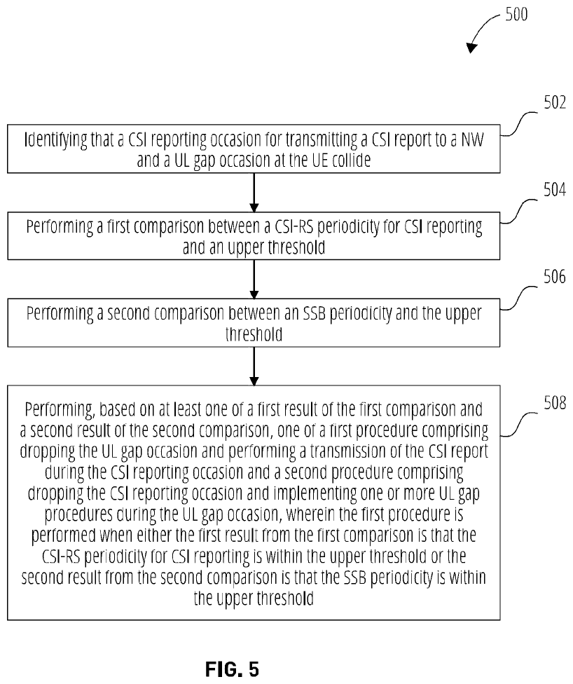

FIG. 5 illustrates a method 500 of a UE, according to an embodiment. The method 500 includes identifying 502 that a CSI reporting occasion for transmitting a CSI report to a NW and a UL gap occasion at the UE collide.

The method 500 further includes performing 504 a first comparison between a CSI-RS periodicity for CSI reporting and an upper threshold.

The method 500 further includes performing 506 a second comparison between an SSB periodicity and the upper threshold.

The method 500 further includes performing 508, based on at least one of a first result of the first comparison and a second result of the second comparison, one of a first procedure comprising dropping the UL gap occasion and performing a transmission of the CSI report during the CSI reporting occasion and a second procedure comprising dropping the CSI reporting occasion and implementing one or more UL gap procedures during the UL gap occasion, wherein the first procedure is performed when either the first result from the first comparison is that the CSI-RS periodicity for CSI reporting is within the upper threshold or the second result from the second comparison is that the SSB periodicity.

In some embodiments of the method 500, the upper threshold is indicated by the NW.

In some embodiments of the method 500, the CSI report is for a SCell activation procedure for a target SCell. In some of these embodiments, the target SCell is an FR2 cell. In some of these embodiments, the activation procedure is for one of intra-band FR2 CA and inter-band FR2 CA with CBA.

Embodiments contemplated herein include an apparatus comprising means to perform one or more elements of the method 500. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 500. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a UE (such as a wireless device 1002 that is a UE, as described herein).

Embodiments contemplated herein include a signal as described in or related to one or more elements of the method 500.

Embodiments contemplated herein include a computer program or computer program product comprising instructions, wherein execution of the program by a processor is to cause the processor to carry out one or more elements of the method 500. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Some methods for prioritizing between UL gap occasions and CSI reporting occasions that collide during SCell activation may consider a CSI reporting type and/or a CSI reporting periodicity. Example cases where the use of a CSI reporting type and/or a CSI reporting periodicity may be relevant are cases where the UE is performing SCell activation for inter-band FR2 CA where independent beam management (IBM) is used. In such cases, it cannot be assumed that there is alignment between SSBs between the SCell and one or more serving cell(s).

Some methods for prioritizing between a UL gap occasion and a CSI reporting occasion that collide during SCell activation may consider a CSI reporting type for a CSI report to be sent during the CSI reporting occasion. In such cases, the UE may determine whether (or not) the CSI report is a first valid CSI report. A first valid CSI report may be a first CSI report to be transmitted by the UE within the SCell activation process that has a CQI greater than 0 (meaning that the CSI report corresponds to a successful channel measurement and thus contains measurement data).

If the CSI report is a first valid CSI report, then the UE prioritizes the CSI reporting occasion over the UL gap occasion. In other words, the UE may drop the UL gap occasion and perform a transmission of the CSI report during the CSI reporting occasion. This may reflect the understanding that a first valid CSI report of a SCell activation process has data that is desirable to successfully to proceeding with the SCell activation process, and which may be urgent. Otherwise, if the CSI report is not a first valid CSI report (e.g., it has a CQI=0, and/or it is not the first CSI report within the SCell activation process that has a CQI greater than zero), then the UE prioritizes the UL gap occasion over the CSI reporting occasion. In other words, the UE drops the CSI reporting occasion and implements one or more UL gap procedures during the UL gap occasion.

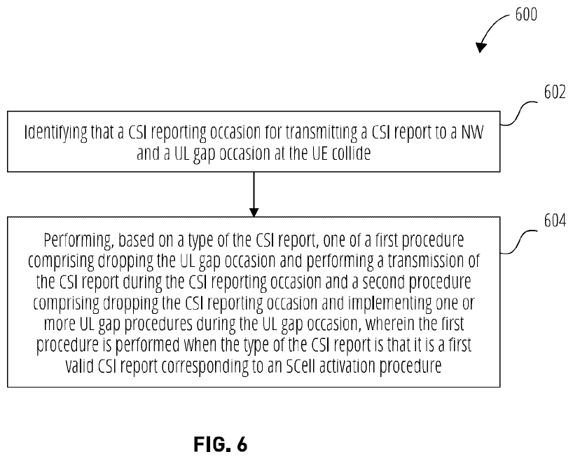

FIG. 6 illustrates a method 600 of a UE, according to an embodiment. The method 600 includes identifying 602 that a CSI reporting occasion for transmitting a CSI report to a NW and a UL gap occasion at the UE collide.

The method 600 further includes performing 604, based on a type of the CSI report, one of a first procedure comprising dropping the UL gap occasion and performing a transmission of the CSI report during the CSI reporting occasion and a second procedure comprising dropping the CSI reporting occasion and implementing one or more UL gap procedures during the UL gap occasion, wherein the first procedure is performed when the type of the CSI report is that it is a first valid CSI report corresponding to an SCell activation procedure.

In some embodiments of the method 600, the upper threshold is indicated by the NW.

Embodiments contemplated herein include an apparatus comprising means to perform one or more elements of the method 600. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 600. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 1002 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Some methods for prioritizing between a UL gap occasion and a CSI reporting occasion that collide during SCell activation may consider a CSI reporting periodicity being used by the UE. Such prioritization may be performed based on the result of a comparison of the CSI reporting periodicity to an upper threshold. In such cases, a CSI reporting periodicity may correspond to a set of CSI reporting occasions that includes the CSI reporting occasion.

In a first option for prioritizing one of the CSI reporting occasion and the UL gap occasion using the CSI reporting periodicity, if the result of the comparison of the CSI reporting periodicity to the upper threshold is that the CSI reporting periodicity is within the upper threshold (e.g., is less than or alternatively is less than or equal to the upper threshold), the UE prioritizes the UL gap occasion over the CSI reporting occasion. In other words, the UE may drop the CSI reporting occasion and implement one or more UL gap procedures during the UL gap occasion. The prioritization of the UL gap occasion over the CSI reporting occasion in this case may reflect an understanding that because the CSI reporting periodicity is smaller than the upper threshold, there may be other CSI reporting occasion(s) during which the CSI report can be transmitted within an acceptable timeframe even after the present CSI reporting occasion is dropped.

Otherwise, if the CSI reporting periodicity is not within the upper threshold (e.g., is greater than or alternatively greater than or equal to the upper threshold), the UE prioritizes the CSI reporting occasion over the UL gap. In other words, the UE may drop the UL gap occasion and perform a transmission of the CSI report during the first CSI reporting occasion. The prioritization of the CSI reporting occasion over the UL gap occasion in this case may reflect an understanding that because the CSI reporting periodicity at the UE is larger than the upper threshold, there may be no other CSI reporting occasion(s) during which a CSI report can be transmitted that are within an acceptable timeframe if the current CSI reporting occasion is dropped.

In a second option for prioritizing one of the CSI reporting occasion and the UL gap occasion using the CSI reporting periodicity, if the result of the comparison of the CSI reporting periodicity to the upper threshold is that the CSI reporting periodicity is within the upper threshold (e.g., is less than or alternatively is less than or equal to the upper threshold), the possibility that the UE prioritizes the UL gap occasion over the CSI reporting periodicity (as in the first option for prioritizing one of the CSI reporting occasion and the UL gap occasion using the CSI reporting periodicity) is left open, pending a second result of a second comparison regarding a second CSI reporting periodicity that would apply at the UE in the case that one or more CSI reporting occasions (including the CSI reporting occasion that collides with the UL gap) of the set of CSI reporting occasions are dropped.

In such cases, the UE may determine a second CSI reporting periodicity that exists between remaining ones of the CSI reporting occasions if the one or more CSI reporting occasions (including the CSI reporting occasion that collides with the UL gap) is in fact dropped. The UE then compares this second CSI reporting periodicity to the upper threshold.

In the case that the second CSI reporting periodicity is within the upper threshold (e.g., is less than or alternatively is less than or equal to the upper threshold), the UE prioritizes the UL gap occasion over the CSI reporting occasion. In other words, the UE may drop the CSI reporting occasion and implement one or more UL gap procedures during the UL gap occasion. The prioritization of the UL gap occasion over the CSI reporting occasion in this case may reflect an understanding that because the second CSI reporting periodicity is smaller than the upper threshold, there may be other CSI reporting occasion(s) during which the CSI report can be transmitted within an acceptable timeframe even after the proposed one or more CSI reporting occasions (including the present CSI reporting occasion) is actually dropped.

If the result of the second comparison is instead that the CSI reporting periodicity is not within the upper threshold (e.g., is greater than or alternatively is greater than or equal to the upper threshold), the UE would instead prioritize the CSI reporting occasion over the UL gap occasion. In other words, the UE may drop the present UL gap occasion and perform a transmission of the CSI report during the first CSI reporting occasion. The prioritization of the CSI reporting occasion over the UL gap occasion in this case may reflect an understanding that because the second CSI reporting periodicity is larger than the upper threshold, there may not be other CSI reporting occasion(s) during which the CSI report can be transmitted within an acceptable timeframe if the proposed one or more CSI reporting occasions (including the present CSI reporting occasion) were actually dropped.

In some of these embodiments, an upper threshold is pre-defined at the UE. In some of these embodiments, the upper threshold may be configured to the UE by the NW.

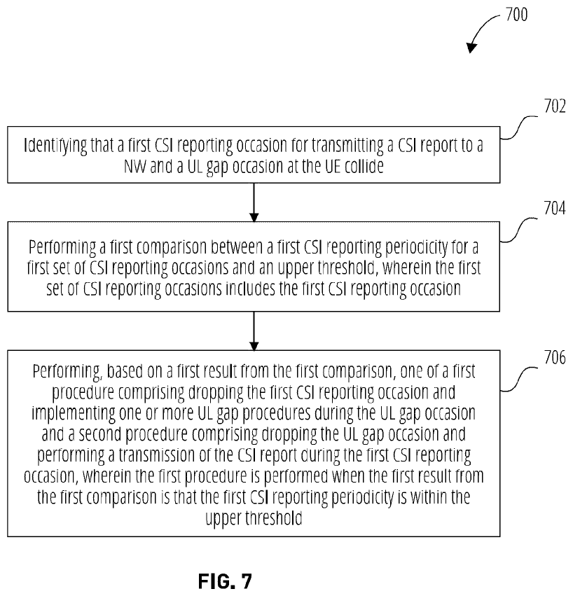

FIG. 7 illustrates a method 700 of a UE, according to an embodiment. In identifying 702, method 700 identifies that a first CSI reporting occasion for transmitting a CSI report to a NW and a UL gap occasion at the UE collide.

The method 700 further includes performing 704, a first comparison between a first CSI reporting periodicity for a first set of CSI reporting occasions and an upper threshold, wherein the first set of CSI reporting occasions includes the first CSI reporting occasion.

The method 700 further includes performing 706, based on a first result from the first comparison, one of a first procedure comprising dropping the first CSI reporting occasion and implementing one or more UL gap procedures during the UL gap occasion and a second procedure comprising dropping the UL gap occasion and performing a transmission of the CSI report during the first CSI reporting occasion, wherein the first procedure is performed when the first result from the first comparison is that the first CSI reporting periodicity is within the upper threshold.

In some embodiments, the method 700 further includes determining a second CSI reporting periodicity for a second set of CSI reporting occasions, wherein the second set of CSI reporting occasions is a subset of the first set of CSI reporting occasions that excludes the first CSI reporting occasion, and performing a second comparison between the second CSI reporting periodicity and the upper threshold, wherein the performing the one of the first procedure and the second procedure is further based on a second result from the second comparison, and wherein the first procedure is performed when the result from the second comparison is that the second CSI reporting periodicity is within the upper threshold.

In some embodiments of the method 700, the upper threshold is indicated by the NW.

Embodiments contemplated herein include an apparatus comprising means to perform one or more elements of the method 700. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 700. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 1002 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

Some methods for prioritizing between a UL gap occasion and a CSI reporting occasion that collide during SCell activation may consider both a CSI reporting type for a CSI report to be sent during the CSI reporting occasion and a CSI reporting periodicity being used by the UE. In such cases, the UE may determine whether (or not) the CSI report is a first valid CSI report. Further, the UE may perform a comparison of the CSI reporting periodicity to an upper threshold. In such cases, the CSI reporting periodicity may correspond to a set of CSI reporting occasions that includes the CSI reporting occasion.

In a first option for prioritizing one of the CSI reporting occasion and the UL gap occasion using the CSI reporting type and the CSI reporting periodicity, if the CSI report is a first valid CSI report, then the UE prioritizes the CSI reporting occasion over the UL gap occasion. In other words, the UE may drop the UL gap occasion and perform a transmission of the CSI report during the CSI reporting occasion. This may reflect the understanding that a first valid CSI report of a SCell activation process has data that is desirable to successfully to proceeding with the SCell activation process, and may be urgent.

Otherwise, if the CSI report is not a first valid CSI report, then the UE proceeds to a comparison of the CSI reporting periodicity to an upper threshold in order to determine a prioritization between the CSI reporting occasion and the UL gap occasion.

In such a circumstance, if the result of the comparison of the CSI reporting periodicity to the upper threshold is that the CSI reporting periodicity is within the upper threshold (e.g., is less than or alternatively is less than or equal to the upper threshold), the UE prioritizes the UL gap occasion over the CSI reporting occasion. In other words, the UE may drop the CSI reporting occasion and implement one or more UL gap procedures during the UL gap occasion. The prioritization of the UL gap occasion over the CSI reporting occasion in this case may reflect an understanding that because the CSI reporting periodicity is smaller than the upper threshold, there may be other CSI reporting occasion(s) during which the CSI report can be transmitted within an acceptable timeframe even after the present CSI reporting occasion is dropped.

Otherwise, if the CSI reporting periodicity is not within the upper threshold (e.g., is greater than or alternatively greater than or equal to the upper threshold), the UE prioritizes the CSI reporting occasion over the UL gap. In other words, the UE may drop the UL gap occasion and perform a transmission of the CSI report during the first CSI reporting occasion. The prioritization of the CSI reporting occasion over the UL gap occasion in this case may reflect an understanding that because the CSI reporting periodicity at the UE is larger than the upper threshold, there may be no other CSI reporting occasion(s) during which a CSI report can be transmitted that are within an acceptable timeframe if the current CSI reporting occasion is dropped.

In a second option for prioritizing one of the CSI reporting occasion and the UL gap occasion using the CSI reporting type and the CSI reporting periodicity, the CSI reporting type is used as in the first option for prioritizing one of the CSI reporting occasion and the UL gap occasion using the CSI reporting type and the CSI reporting periodicity (e.g., the UE proceeds to use the result of the comparison of the CSI reporting periodicity to the upper threshold in the case where the prioritization of the CSI report is not necessarily called for per the CSI reporting type of the CSI report).

In this second option, if the result of the comparison of the CSI reporting periodicity to the upper threshold is that the CSI reporting periodicity is within the upper threshold (e.g., is less than or alternatively is less than or equal to the upper threshold), the possibility that the UE prioritizes the UL gap occasion over the CSI reporting periodicity (as in the first option for prioritizing one of the CSI reporting occasion and the UL gap occasion using the CSI reporting type and the CSI reporting periodicity) is left open, pending a second result of a second comparison regarding a second CSI reporting periodicity that would apply at the UE in the case that one or more CSI reporting occasions (including the CSI reporting occasion that collides with the UL gap) of the set of CSI reporting occasions are dropped.

In such cases, the UE may determine a second CSI reporting periodicity that exists between remaining ones of the CSI reporting occasions if the one or more CSI reporting occasions (including the CSI reporting occasion that collides with the UL gap) is in fact dropped. The UE then compares this second CSI reporting periodicity to the upper threshold.

In the case that the second CSI reporting periodicity is within the upper threshold (e.g., is less than or alternatively is less than or equal to the upper threshold), the UE prioritizes the UL gap occasion over the CSI reporting occasion. In other words, the UE may drop the CSI reporting occasion and implement one or more UL gap procedures during the UL gap occasion. The prioritization of the UL gap occasion over the CSI reporting occasion in this case may reflect an understanding that because the second CSI reporting periodicity is smaller than the upper threshold, there may be other CSI reporting occasion(s) during which the CSI report can be transmitted within an acceptable timeframe even if the proposed one or more CSI reporting occasions (including the present CSI reporting occasion) is actually dropped.

If the result of the second comparison is instead that the CSI reporting periodicity is not within the upper threshold (e.g., is greater than or alternatively is greater than or equal to the upper threshold), the UE would instead prioritize the CSI reporting occasion over the UL gap occasion. In other words, the UE may drop the present UL gap occasion and perform a transmission of the CSI report during the first CSI reporting occasion. The prioritization of the CSI reporting occasion over the UL gap occasion in this case may reflect an understanding that because the second CSI reporting periodicity is larger than the upper threshold, there may not be other CSI reporting occasion(s) during which the CSI report can be transmitted within an acceptable timeframe if the proposed one or more CSI reporting occasions (including the present CSI reporting occasion) were actually dropped.

In some of these embodiments, an upper threshold is pre-defined at the UE. In some of these embodiments, the upper threshold may be configured to the UE by the NW.

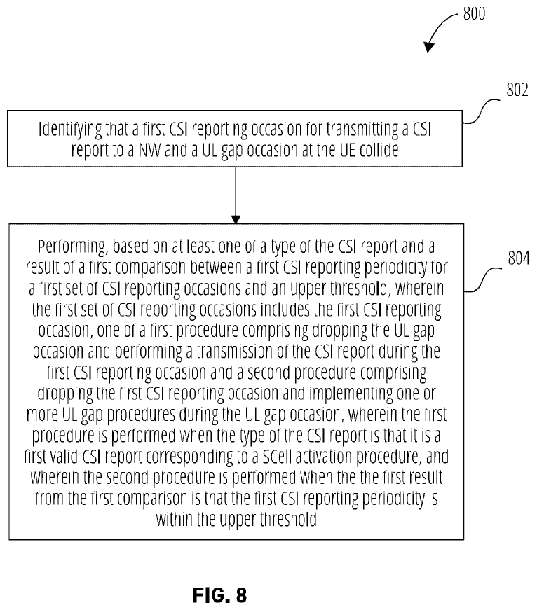

FIG. 8 illustrates a method 800 of a UE, according to an embodiment. The method 800 includes identifying 802 that a first CSI reporting occasion for transmitting a CSI report to a NW and a UL gap occasion at the UE collide.

The method 800 further includes performing 804, based on at least one of a type of the CSI report and a result of a first comparison between a first CSI reporting periodicity for a first set of CSI reporting occasions and an upper threshold, wherein the first set of CSI reporting occasions includes the first CSI reporting occasion, one of a first procedure comprising dropping the UL gap occasion and performing a transmission of the CSI report during the first CSI reporting occasion and a second procedure comprising dropping the first CSI reporting occasion and implementing one or more UL gap procedures during the UL gap occasion, wherein the first procedure is performed when the type of the CSI report is that it is a first valid CSI report corresponding to a SCell activation procedure, and wherein the second procedure is performed when the first result from the first comparison is that the first CSI reporting periodicity is within the upper threshold.

In some embodiments of the method 800 wherein the performing the one of the first procedure and the second procedure is based on the result of the first comparison and not on the type of the CSI report, the method 800 further includes determining a second CSI reporting periodicity for a second set of CSI reporting occasions, wherein the second set of CSI reporting occasions is a subset of the first set of CSI reporting occasions that excludes the first CSI reporting occasion and performing a second comparison between the second CSI reporting periodicity and the upper threshold, wherein the performing the one of the first procedure and the second procedure is further based on a second result from the second comparison, and wherein the second procedure is performed when the result from the second comparison is that the second CSI reporting periodicity is within the upper threshold.

In some embodiments of the method 800, the upper threshold is indicated by the NW.

Embodiments contemplated herein include an apparatus comprising means to perform one or more elements of the method 800. This apparatus may be, for example, an apparatus of a UE (such as a wireless device 1002 that is a UE, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a UE (such as a memory 1006 of a wireless device 1002 that is a UE, as described herein).

Embodiments contemplated herein include an apparatus comprising logic, modules, or circuitry to perform one or more elements of the method 800. This apparatus may be, for example, an apparatus of a UE (such as a wireless device 1002 that is a UE, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a UE (such as a wireless device 1002 that is a UE, as described herein).

Embodiments contemplated herein include a signal as described in or related to one or more elements of the method 800.

Embodiments contemplated herein include a computer program or computer program product comprising instructions, wherein execution of the program by a processor is to cause the processor to carry out one or more elements of the method 800. The processor may be a processor of a UE (such as a processor(s) 1004 of a wireless device 1002 that is a UE, as described herein). These instructions may be, for example, located in the processor and/or on a memory of the UE (such as a memory 1006 of a wireless device 1002 that is a UE, as described herein).

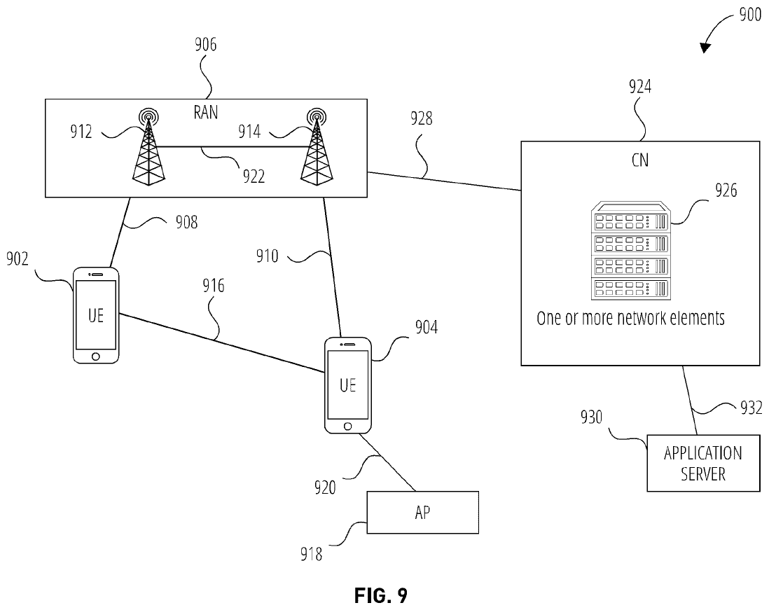

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations, such as base station 912 and base station 914, that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi© router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

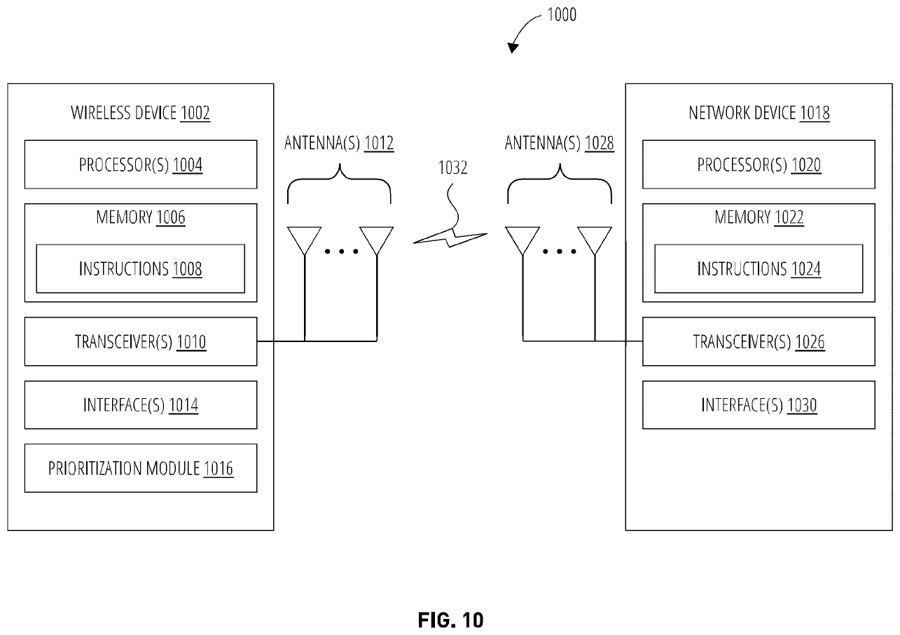

FIG. 10 illustrates a system 1000 for performing signaling 1032 between a wireless device 1002 and a network device 1018, according to embodiments disclosed herein. The system 1000 may be a portion of a wireless communications system as herein described. The wireless device 1002 may be, for example, a UE of a wireless communication system. The network device 1018 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1032) to and/or from the wireless device 1002 with other devices (e.g., the network device 1018) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1010/antenna(s) 1012 already described) that allow for communication between the UE and other devices and may operate according to known protocols (e.g., Wi-Fi©, Bluetooth®, and the like).

The wireless device 1002 may include a prioritization module 1016. The prioritization module 1016 may be implemented via hardware, software, or combinations thereof. For example, the prioritization module 1016 may be implemented as a processor, circuit, and/or instructions 1008 stored in the memory 1006 and executed by the processor(s) 1004. In some examples, the prioritization module 1016 may be integrated within the processor(s) 1004 and/or the transceiver(s) 1010. For example, the prioritization module 1016 may be implemented by a combination of software components (e.g., executed by a DSP or a general processor) and hardware components (e.g., logic gates and circuitry) within the processor(s) 1004 or the transceiver(s) 1010.

The prioritization module 1016 may be used for various aspects of the present disclosure, for example, aspects of FIG. 1 through FIG. 8. The prioritization module 1016 is configured to, for example, make prioritization determinations between UL gap occasions and one or more of PRS measurement occasions, UL-PRS transmission occasions, and/or CSI reporting occasions, as is described herein.

The network device 1018 may include one or more processor(s) 1020. The processor(s) 1020 may execute instructions such that various operations of the network device 1018 are performed, as described herein. The processor(s) 1020 may include one or more baseband processors implemented using, for example, a CPU, a DSP, an ASIC, a controller, an FPGA device, another hardware device, a firmware device, or any combination thereof configured to perform the operations described herein.

The network device 1018 may include a memory 1022. The memory 1022 may be a non-transitory computer-readable storage medium that stores instructions 1024 (which may include, for example, the instructions being executed by the processor(s) 1020). The instructions 1024 may also be referred to as program code or a computer program. The memory 1022 may also store data used by, and results computed by, the processor(s) 1020.

The network device 1018 may include one or more transceiver(s) 1026 that may include RF transmitter and/or receiver circuitry that use the antenna(s) 1028 of the network device 1018 to facilitate signaling (e.g., the signaling 1032) to and/or from the network device 1018 with other devices (e.g., the wireless device 1002) according to corresponding RATs.

The network device 1018 may include one or more antenna(s) 1028 (e.g., one, two, four, or more). In embodiments having multiple antenna(s) 1028, the network device 1018 may perform MIMO, digital beamforming, analog beamforming, beam steering, etc., as has been described.

The network device 1018 may include one or more interface(s) 1030. The interface(s) 1030 may be used to provide input to or output from the network device 1018. For example, a network device 1018 that is a base station may include interface(s) 1030 made up of transmitters, receivers, and other circuitry (e.g., other than the transceiver(s) 1026/antenna(s) 1028 already described) that enables the base station to communicate with other equipment in a core network, and/or that enables the base station to communicate with external networks, computers, databases, and the like for purposes of operations, administration, and maintenance of the base station or other equipment operably connected thereto.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
identifying that a first positioning reference signal (PRS) measurement occasion for measuring a PRS transmitted by a network (NW) and an uplink (UL) gap occasion at the UE collide;
performing a first comparison between a first effective periodicity for a first set of PRS measurement occasions and an upper threshold; wherein the first set of PRS measurement occasions includes the first PRS measurement occasion; and
performing, based on a first result from the first comparison, one of:
a first procedure comprising dropping the first PRS measurement occasion and implementing one or more UL gap procedures during the UL gap occasion; and
a second procedure comprising dropping the UL gap occasion and performing a measurement of the PRS during the first PRS measurement occasion;
wherein the first procedure is performed when the first result from the first comparison is that the first effective periodicity for the first set of PRS measurement occasions is within the upper threshold.

2. The method of claim 1, further comprising:
determining a second effective periodicity for a second set of PRS measurement occasions; wherein the second set of PRS measurement occasions is a subset of the first set of PRS measurement occasions that excludes the first PRS measurement occasion; and
performing a second comparison between the second effective periodicity for the second set of PRS measurement occasions and the upper threshold;
wherein the performing the one of the first procedure and the second procedure is further based on a second result from the second comparison, and
wherein the first procedure is performed when the result from the second comparison is that the second effective periodicity for the second set of PRS measurement occasions is within the upper threshold.

3. The method of claim 2, further comprising determining the second set of PRS measurement occasions by omitting one or more PRS measurement occasions including the first PRS measurement occasion from the first set of PRS measurement occasions.

4. The method of claim 1, further comprising determining the first effective periodicity for the first set of PRS measurement occasions by applying a muting pattern to a configured PRS periodicity.

5. The method of claim 1, further comprising receiving, from the NW, the upper threshold.

6. A method of a user equipment (UE), comprising:
identifying that a first uplink positioning reference signal (UL-PRS) transmission occasion for transmitting a UL-PRS to a network (NW) and an uplink (UL) gap occasion at the UE collide;
performing a first comparison between a first effective periodicity for a first set of UL-PRS transmission occasions and an upper threshold; wherein the first set of UL-PRS transmission occasions includes the first UL-PRS transmission occasion; and
performing, based on a first result from the first comparison, one of:
a first procedure comprising dropping the first UL-PRS transmission occasion and implementing one or more UL gap procedures during the UL gap occasion; and
a second procedure comprising dropping the UL gap occasion and performing a transmission of the UL-PRS during the first UL-PRS transmission occasion;
wherein the first procedure is performed when the first result from the first comparison is that the effective periodicity for the first set of UL-PRS transmission occasions is within the upper threshold.

7. The method of claim 6, further comprising:
determining a second effective periodicity for a second set of UL-PRS transmission occasions; wherein the second set of UL-PRS transmission occasions is a subset of the first set of UL-PRS transmission occasions that excludes the first UL-PRS transmission occasion; and
performing a second comparison between the second effective periodicity for the second set of UL-PRS transmission occasions and the upper threshold;
wherein the performing the one of the first procedure and the second procedure is further based on a second result from the second comparison, and
wherein the first procedure is performed when the result from the second comparison is that the second effective periodicity for the second set of UL-PRS transmission occasions is within the upper threshold.

8. The method of claim 7, further comprising determining the second set of UL-PRS transmission occasions by omitting one or more UL-PRS transmission occasions including the first UL-PRS transmission occasion from the first set of UL-PRS transmission occasions.

9. The method of claim 6, further comprising determining the first effective periodicity for the first set of UL-PRS transmission occasions by applying a muting pattern to a configured UL-PRS periodicity.

10. The method of claim 6, further comprising receiving, from the NW, the upper threshold.

11. The method of claim 6, wherein the UL-PRS is a sounding reference signal (SRS).

12. A method of a user equipment (UE), comprising:
identifying that a channel state information (CSI) reporting occasion for transmitting a CSI report to a network (NW) and an uplink (UL) gap occasion at the UE collide;
performing a first comparison between a CSI reference signal (CSI-RS) periodicity for CSI reporting and an upper threshold;
performing a second comparison between a synchronization signal block (SSB) periodicity and the upper threshold;
performing, based on at least one of a first result of the first comparison and a second result of the second comparison, one of:
a first procedure comprising dropping the UL gap occasion and performing a transmission of the CSI report during the CSI reporting occasion; and
a second procedure comprising dropping the CSI reporting occasion and implementing one or more UL gap procedures during the UL gap occasion;
wherein the first procedure is performed when either:
the first result from the first comparison is that the CSI-RS periodicity for CSI reporting is within the upper threshold; or
the second result from the second comparison is that the SSB periodicity is within the upper threshold.

13. The method of claim 12, wherein the upper threshold is indicated by the NW.

14. The method of claim 12, wherein the CSI report is for a secondary cell (SCell) activation procedure for a target SCell.

15. The method of claim 14, wherein the target SCell is a frequency range 2 (FR2) cell.

16. The method of claim 14, wherein the activation procedure is for one of intra-band frequency range 2 (FR2) carrier aggregation (CA) and inter-band FR2 CA with common beam management (CBM).

17-21. (canceled)
